(19) United States
(12) Patent Application Publication
(10) Pub. No.: US 2006/0139676 A1
(43) Pub. Date: Jun. 29, 2006

(54) Printing control apparatus and method thereof

(75) Inventor: Man-chan Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/318,618

(22) Filed: Dec. 28, 2005

(30) Foreign Application Priority Data
Dec. 28, 2004 (KR) 10-2004-0114446

(51) Int. Cl. G06F 3/12

(52) U.S. Cl. 358/1.13

(57) ABSTRACT

A printing control apparatus and method thereof are provided that provide a clone printing option for printing a plurality of identical printing-object documents of a certain clone size on a single sheet of printing paper. The apparatus includes an application program unit for creating a printing-object document in a certain size, and a printer driver unit for modifying the size of the created document to a clone size by transferring the clone size to the application program unit when the clone size is determined, and creating print data by applying the clone printing option to the modified document. Accordingly, margins occurring on the sheets of printed paper are minimized without having image distortion, and an image can be clone printed in the size that a user desires.

### CROSS-REFERENCE TO RELATED APPLICATIONS

This application claims the benefit under 35 U.S.C. § 119(a) of Korean Patent Application No. 10-2004-0114446, filed in the Korean Intellectual Property Office on Dec. 28, 2004, the entire disclosure of which is incorporated herein by reference.

### BACKGROUND OF THE INVENTION

1. Field of the Invention

The present invention relates to a printing control apparatus and a method thereof. More specifically, the present invention relates to a printing control apparatus and a method thereof, which provide a clone printing option for printing a plurality of identical printing-object documents of a certain clone size on a single sheet of paper.

2. Description of the Related Art

Generally, in the case of printing a document created by a computer application program through a printer, a printer driver provided by a printer manufacturer must be installed in the computer in order to control printing functions.

The printer driver provides a UI (User Interface) for setting printing options applied to a printing-object document. A user can determine diverse printing options (for example, print quality, print range, paper type, and so forth) that can be applied to a printing-object document using the UI provided by the printer driver. One of the printing options can be the clone printing option, which is provided for printing a plurality of identical documents of the same size on a single sheet of paper.

FIGS. 1A to 1E illustrate a conventional clone printing option. Referring to FIGS. 1A to 1E, in order to perform a clone printing of a certain image I of FIG. 1A, an application program must first create a document D to be clone printed as shown in FIG. 1B, wherein the document includes the image I. Next, if a user selects the clone printing option together with a clone size through the print option setting window provided by the printer driver, the printer driver applies the clone printing option to a printing-object document so that the document created by an application program can be printed multiple times on a paper in accordance with the size of the clone area C represented by lines in FIG. 1C, and transforms the printing-object document into print data that can be recognized by the printer. Here, the clone size is the size of the clone area C represented by lines in FIG. 1C, that is, a unit size of the identical document that is to be printed on a single sheet of paper multiple times.

Generally, the size of a document created by an application program is determined by the size of the paper P on which the document is actually printed, that is, the size of paper being supported by the printer driver. The printer driver transfers only the information regarding the size of paper on which a document is actually printed to the application program in order to create a document. Accordingly, when performing a clone printing operation in a conventional method, a process is required for shrinking a document created by an application program to fit in the clone size. At this point, in the case where the ratio of width to length of a document D created by an application program is different from the ratio of width to length of the clone size, margins corresponding to the lines of FIG. 1C occur. Furthermore, in the case where the ratio of width to length of an image I to be clone printed is different from the ratio of width and length of a printing-object document D, and the ratio of a printing-object document is determined by the size of a printing paper supported by the printer driver, an unwanted empty space S occurs as shown in FIG. 1B when a document is created, so that the image I cannot be printed in the clone size that a user actually desires.

In addition, in the case where the image I of FIG. 1A fills a document D without leaving any margin, portions of the left, right, top, and bottom areas are cut off from the enlarged image I′ of a document as shown in FIG. 1D, or the document is transformed into an image I″ that is enlarged asymmetrically as shown in FIG. 1E, so that a distorted image is printed.

Accordingly, a need exists for a system and method which can clone print an image in a desired size and control margins occurring on the printing paper without image distortion.

### SUMMARY OF THE INVENTION

Embodiments of the present invention have been made in order to substantially solve the above and other problems in the art. An object of the present invention is to provide a printing control apparatus and a method thereof, which can minimize margins occurring on printing paper without having image distortion and which can clone print an image in the size that a user desires.

According to one aspect of embodiments of the present invention for achieving the objects, a printing control apparatus is provided for providing a clone printing option for printing a plurality of identical printing-object documents of a certain clone size on a single sheet of paper, the apparatus comprising an application program unit for creating a printing-object document in a certain size, and a printer driver unit for modifying the size of the created document to a clone size by transferring the clone size to the application program unit when the clone size is determined and creating print data by applying the clone printing option to the modified document.

In addition, the apparatus may further comprise a communication interface unit for providing the print data created by the printer driver to an external printing device.

Here, the clone printing option comprises at least one of a clone size, a size of paper on which the modified document is actually printed, a number of documents to be printed on one printing paper, and whether or not the cutting lines partitioning the documents to be printed on one paper are to be displayed.

The printer driver can also create a print option setting window comprising certain printing option items including the clone printing option, and the clone printing option can be selected through the created print option setting window.

According to another aspect of the present invention, a printing control apparatus is provided comprising a printer driver unit provided with a paper size list including clone sizes, and an application program unit for creating a printing-object document according to the paper size selected from the paper size list provided by the printer driver. If the selected paper size is the same as the clone size, the printer driver creates print data by automatically applying the clone printing option to the created printing-object document.

In addition, the apparatus may further comprise a communication interface unit for providing the print data created by the printer driver to an external printing device.

Here, the clone printing option comprises at least one of a size of paper on which the created document is actually printed, a number of documents to be printed on a single sheet of paper, and whether or not the cutting lines partitioning the documents to be printed on a single sheet of paper are to be displayed.

The application program unit can also create a print setting window comprising certain printing option items including the paper size list, and create a printing-object document according to the paper size selected through the created print setting window.

According to another aspect of the present invention, a printing control method is provided for providing a clone printing option for printing a plurality of identical printing-object documents of a certain clone size on a single sheet of paper. The method comprises the steps of displaying a print option setting window comprising certain printing option items to be applied to a printing-object document, transferring the clone size to the application program unit creating the printing-object document if the clone printing option is determined through the displayed print option setting window, modifying the size of the printing-object document to the transferred clone size, and creating print data by applying the clone printing option to the modified printing-object document.

In addition, the method may further comprise the step of providing the print data to an external printing device.

Here, the clone printing option preferably comprises at least one of the clone size, the size of paper on which the modified document is actually printed, the number of documents to be printed on a single sheet of paper, and whether or not the cutting lines partitioning the documents to be printed on a single sheet of paper are to be displayed.

According to another aspect of the present invention, a printing control method is provided comprising the steps of providing a paper size list including clone sizes to the application program unit for creating a printing-object document, displaying a print setting window comprising certain printing option items including the provided paper size list, selecting a paper size to be used for printing the printing-object document through the displayed print setting window, modifying the size of the printing-object document according to the selected paper size, and creating print data by automatically applying the clone printing option to the created printing-object document if the selected paper size is the clone size.

Here, the clone printing option preferably comprises at least one of a size of paper on which the created printing-object document is actually printed, a number of documents to be printed on a single sheet of paper, and whether or not the cutting lines partitioning the documents to be printed on a single sheet of paper are to be displayed.

In addition, the method may further comprise the step of providing the created print data to an external printing device.

### BRIEF DESCRIPTION OF THE DRAWINGS

The above aspects and features of the present invention will become more apparent by describing certain embodiments of the present invention with reference to the accompanying drawings, in which:

FIGS. 1A through 1E illustrate a conventional clone printing option;

FIG. 2 is a block diagram of a printing system applying a printing control apparatus according to a first embodiment of the present invention;

FIG. 3 illustrates a document printed on a single sheet of printing paper, the document being created in a clone size, according to the first embodiment of the present invention;

FIG. 4 is an example of a print setting window displayed on a display unit when a print command is entered into the application program unit of FIG. 2;

FIG. 5 is a flow chart of a printing control method according to the first embodiment of the present invention; and

FIG. 6 is a flow chart of a printing control method according to a second embodiment of the present invention.

Throughout the drawings, like reference numerals will be understood to refer to like parts, components and structures.

### DETAILED DESCRIPTION OF THE EXEMPLARY EMBODIMENTS

Certain exemplary embodiments of the present invention will now be described in greater detail with reference to the accompanying drawings.

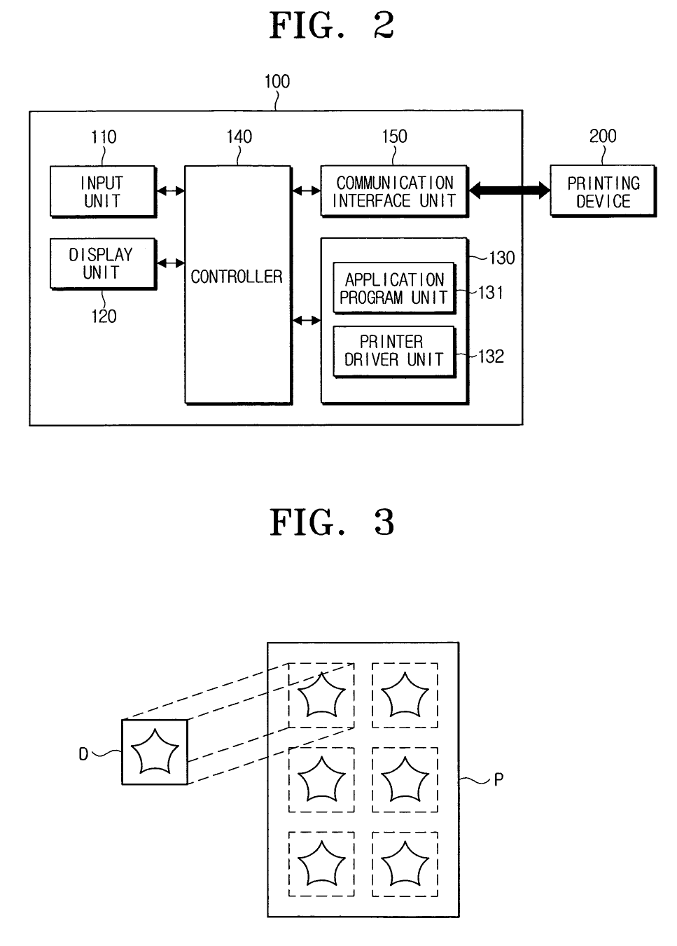

FIG. 2 is a block diagram of a printing system applying a printing control apparatus according to a first embodiment of the present invention.

Referring to FIG. 2, the first embodiment of the present invention is described in greater detail.

According to a first embodiment of the present invention, a printing system comprises a printing control device 100 and a printing device 200. The printing control device 100 can be connected to the printing device 200 through any general connection type, communicating through a USB port and through a LAN (Local Area Network) or an Internet network. Here, the printing device 200 can be embodied as a printer, facsimile machine, or multi-function device, that performs printing operations according to print data provided by the printing control device 100.

The printing control device 100 according to the first embodiment of the present invention comprises an input unit 110, a display unit 120, a storage unit 130, a controller 140, and a communication interface unit 150. The storage unit 130 comprises an application program unit 131 and a printer driver unit 132.

The input unit 110 is a user interface means provided with a plurality of function keys for setting or selecting functions supported by the printing control device 100, and can be embodied as a keyboard or a mouse, but is not limited thereto.

The display unit 120 displays various kinds of information provided by the printing control device 100. The display unit, for example, is a monitor embodied as a CRT (Cathode Ray Tube), LCD (Liquid Crystal Display), or the like. Specifically, the display unit 120 according to the first embodiment of the present invention displays a print setting window and a print option setting window. The print setting window comprises basic printing option items, such as the number of copies, print range, paper size, and the like, provided by the application program unit 131. The print option setting window comprises various printing option items provided by the printer driver unit 132.

The controller 140 controls the general operations of the printing control device 100. According to the first embodiment of the present invention, the controller 140 executes application programs related to generating a printing-object document and programs related to the printer driver unit 132.

The communication interface unit 150 is provided in order to connect the printing control device 100 to an external device. For providing the connection, a parallel port, USB port, wireless module, and the like, can be used. According to the first embodiment of the present invention, the communication interface 150 is used in the exemplary case where printing related data is sent and received between the printing device 200 and the printing control device 100.

The storage unit 130 stores various programs and print data required to implement the functions of the printing control device 100. Specifically, according to the first embodiment of the present invention, the storage unit 130 contains an application program unit 131 and a printer driver unit 132.

The printer driver unit 132 can receive print options (for example, resolution, N-up, shrink print, print range, paper type, and so forth) from a user through the print option setting window to be applied to a printing-object document, that is, the document created by the application program unit 131. The printer driver unit 132 transforms the printing-object document into print data by applying the determined print options to the document, such that the print data is able to be interpreted by the printing device 200.

Hereafter, according to the first embodiment of the present invention, an exemplary operation of the printer driver unit 132 is described in greater detail. When the clone printing option including the clone size is determined through the print option setting window, the printer driver unit 132 transfers the determined clone size to the application program unit 131, and the size of the document being created is modified by the application program unit 131 in accordance with the determined clone size.

Here, the clone printing option preferably includes detail items such as a clone size, the size of paper on which a document is actually printed, the number of documents to be printed on a single sheet of paper, and whether or not the cutting lines partitioning the documents to be printed on a single sheet of paper are to be displayed.

The application program unit 131 stores application programs that are capable of creating various printing-object documents. A user can create a printing-object document using the various application programs stored in the application program unit 131. According to the first embodiment of the present invention, the application program unit 131 modifies the size of a printing-object document according to the clone size determined by the printer driver unit 132. According to this, a user can perform an operation on the document modified to the clone size, the operation being performed on an image to be clone printed.

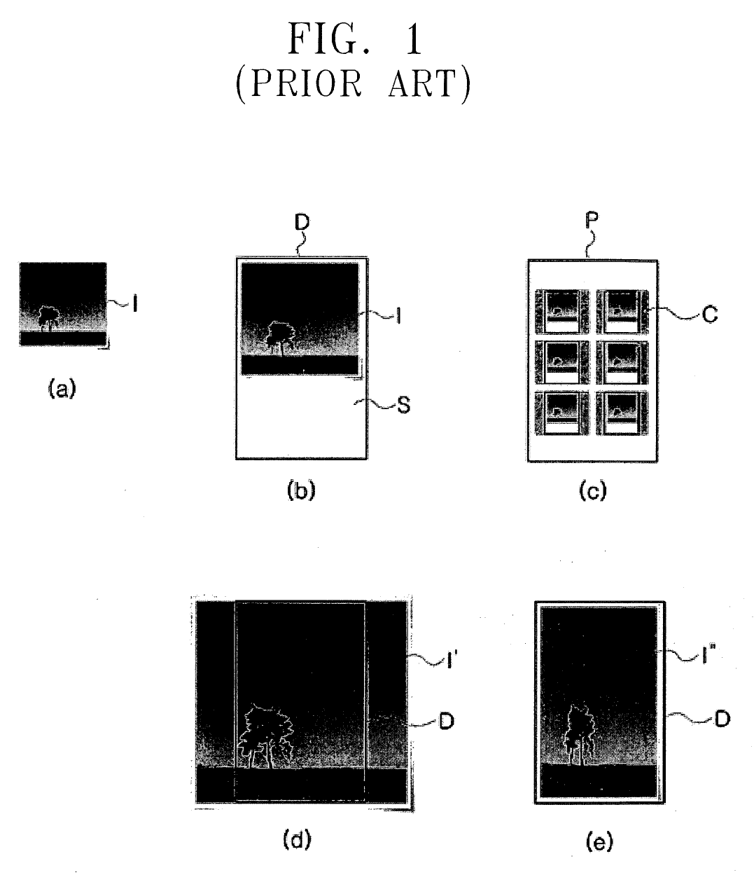

FIG. 3 illustrates a document printed on a single sheet of paper, wherein the document is created in a clone size, according to the first embodiment of the present invention. Referring to FIG. 3, since a document D is already created in a clone size by the application program unit 131, the process of shrinking the document D according to the clone size is not needed as would be required in a conventional clone printing process. Accordingly, the margins corresponding to the lines in FIG. 1C do not occur.

In addition, if the ratio of width to length of a document modified to a clone size is the same as the ratio of width to length of an image to be clone printed, the image can be printed without having any margin within a clone area, so that the image can be printed in the clone size that a user desires.

Next, referring again to FIG. 2, a second embodiment of the present invention is described in greater detail. Here, the operations of the input unit 110, display unit 120, controller 140, and communication interface unit 150 are the same as those of the first embodiment.

The printer driver unit 132 according to the second embodiment of the present invention provides a paper size list to the application program unit 131, wherein the paper size list is formed by appending clone sizes to the paper sizes that are supported for actual printing at the printing device 200. Here, the clone size is determined so as to be smaller than the paper size supported for actual printing at the printing device 200. In addition, if the size of a printing-object document created by the application program unit 131 is the same as the clone size, the printer driver unit 132 creates print data by automatically applying the clone printing option to the printing-object document.

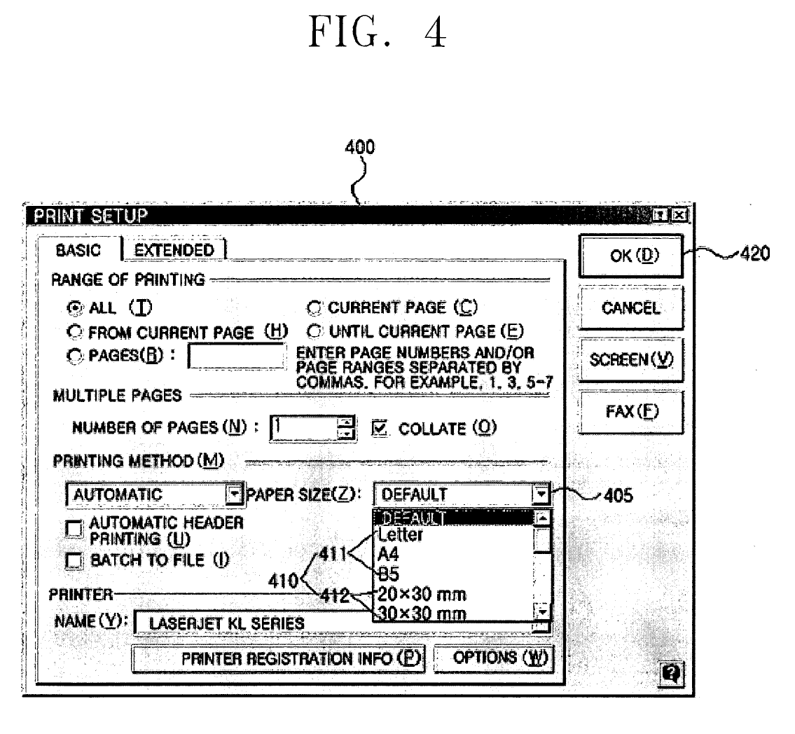

FIG. 4 is an example of a print setting window displayed on a display unit 120 when a print command is entered into the application program unit 131. Referring to FIG. 4, if a print command is entered, the application program unit 131 displays a print setting window 400 comprising certain printing options including the paper size items on the display unit 120, and printing options that can be or those that are selected.

The application program unit 131 provides a paper size list 410 comprising paper sizes 411 (for example, letter, A4 and B5) supported for actual printing, and clone sizes 412 (for example, 20×30 mm, and 30×30 mm), if the paper size button 405 is pressed in the print setting window 400. The application program unit 131 modifies the size of the document being created to the clone size if one of the clone sizes 412 is selected as a paper size. In addition, the application program unit 131 provides a document modified to the clone size to the printer driver unit 132 if the print button 420 is pressed.

Accordingly, the printer driver unit 132 receives a document modified to the clone size, so that the process of shrinking the document does not need to be performed when creating print data according to the clone printing option in the same manner as shown in the first embodiment. Therefore, the margins corresponding to the lines of FIG. 1C do not occur on the materials printed in the clone printing option.

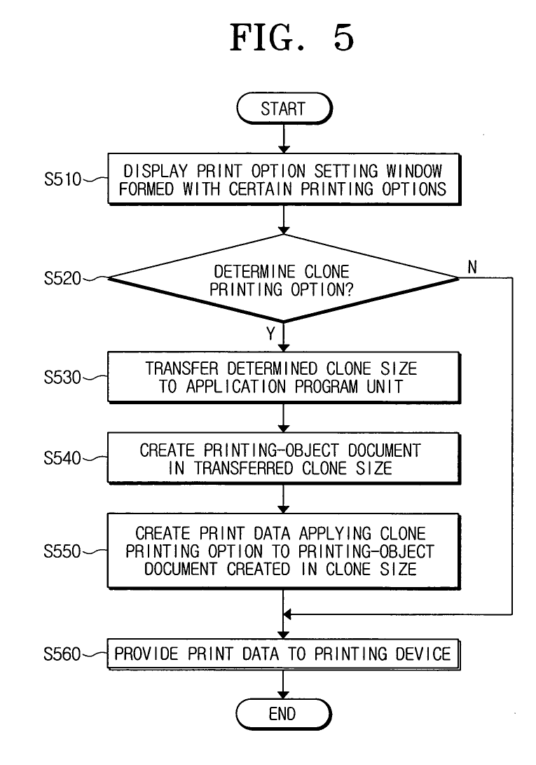

FIG. 5 is a flow chart of a printing control method according to the first embodiment of the present invention.

Referring to FIGS. 2 through 5, if a command for displaying the print option setting window provided by the printer driver unit 132 is entered while the application program unit 131 is creating a document, the printer driver unit 132 displays a print option setting window comprising certain print option items such as resolution, N-up, shrink print, print range, paper size, and the like, on the display unit 120 at step S510.

Then, if the clone printing option including the clone size is determined at step S520 through the print option setting window, the printer driver unit 132 transfers the determined clone size to the application program unit 131 at step S530. If the clone printing option is not determined at step S520, the method proceeds to step S560 where a print operation is performed.

Next, the application program unit 131 creates a printing-object document in the clone size transferred from the printer driver unit 132, and provides the document to the printer driver unit 132 at step S540. Then, the printer driver creates print data at step S550 by applying the clone printing option to the printing-object document created in the clone size by the application program unit 131. In addition, if the paper size to be used for actual printing is determined at the same time in step S520, the printer driver unit 132 applies the information on the determined paper size to the print data. If the paper size is not determined in step S520, the print data is created by applying a paper size predetermined as a default value.

Finally, the printer driver unit 132 transfers the created print data to the printing device 200 through the communication interface unit 150, and a print operation is performed at step S560 according to the clone printing option.

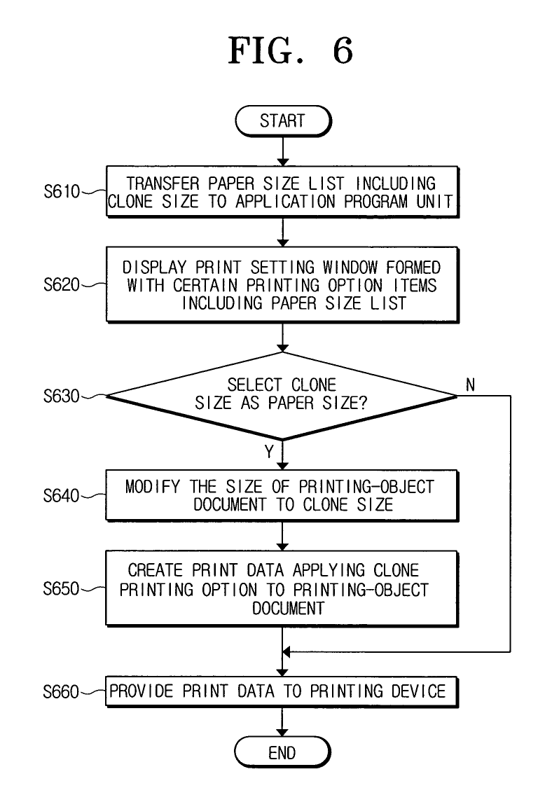

FIG. 6 is a flow chart of a printing control method according to the second embodiment of the present invention.

Referring to FIGS. 2, 4 and 6, the printer driver unit 132 provides a paper size list at step S610 comprising paper sizes that are supported by the printing device 200 for actual printing and clone sizes to the application program unit 131.

Then, if a print command is entered while a document is being created, the application program unit 131 displays a print setting window 400 comprising certain printing options including the paper size item on the display unit 120, and printing options that can be or those that are selected, at step S620.

Then, if one of the clone sizes 412 is selected as a paper size in the print setting window 400 at step S630, the application program unit 131 modifies the size of the document being created to the clone size and then performs a document creating operation at step S640. If one of the clone sizes 412 is not selected at step S630, the method proceeds to step S660 where a print operation is performed.

When the printer driver unit 132 receives the printing-object document modified to the clone size from the application program unit 131, the printer driver unit 132 creates print data at step S650 by automatically applying the clone printing option to the printing-object document.

Finally, the printer driver unit 132 transfers the created print data to the printing device 200 through the communication interface unit 150 in order to perform a printing operation at step S660 according to the clone printing option.

As described above, according to embodiments of the present invention, since the process of shrinking a printing-object document created by the application program unit to a clone size is not required, the margins occurring on the paper can be minimized and the document can be clone printed in the size that a user desires without having distortion.

The foregoing embodiments and advantages are merely exemplary, and are not to be construed as limiting the present invention. The present teachings can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A printing control apparatus providing a clone printing option for printing a plurality of identical printing-object documents of a clone size on a single sheet of printing paper, the apparatus comprising:
an application program unit for creating a printing-object document in a certain size; and
a printer driver unit for modifying the size of the created document to a clone size by transferring the clone size to the application program unit when the clone size is determined, and for creating print data by applying the clone printing option to the modified document.

2. The apparatus as claimed in claim 1, wherein the clone printing option comprises at least one of a clone size, a size of paper on which the modified document is printed, a number of documents to be printed on a single sheet of printing paper, and whether or not cutting lines partitioning the documents to be printed on a single sheet of paper are to be displayed.

3. The apparatus as claimed in claim 1, wherein the printer driver unit is configured to create a print option setting window comprising printing option items including the clone printing option.

4. The apparatus as claimed in claim 3, wherein the clone printing option is selected through the created print option setting window.

5. The apparatus as claimed in claim 1, further comprising:
a communication interface unit for providing the print data created by the printer driver to an external printing device.

6. A printing control apparatus providing a clone printing option for printing a plurality of identical printing-object documents of a clone size on a single sheet of printing paper, the apparatus comprising:
a printer driver unit comprising a paper size list including clone sizes; and
an application program unit for creating a printing-object document according to the paper size selected from the paper size list provided by the printer driver unit, wherein, if the selected paper size is the same as a clone size, the printer driver unit is configured to create print data by automatically applying a clone printing option to the created printing-object document.

7. The apparatus as claimed in claim 6, wherein the clone printing option comprises at least one of a size of paper on which the created document is printed, a number of documents to be printed on a single sheet of printing paper, and whether or not cutting lines partitioning the documents to be printed on a single sheet of paper are to be displayed.

8. The apparatus as claimed in claim 6, wherein the application program unit is configured to create a print setting window comprising printing option items including the paper size list, and create a printing-object document according to the paper size selected through the created print setting window.

9. The apparatus as claimed in claim 6, further comprising:
a communication interface unit for providing the print data created by the printer driver to an external printing device.

10. A printing control method providing a clone printing option for printing a plurality of identical printing-object documents of a clone size on a single sheet of printing paper, the method comprising the steps of:
displaying a print option setting window comprising printing option items to be applied to a printing-object document;
transferring a clone size to an application program unit for creating the printing-object document if the clone printing option is determined through the displayed print option setting window;
modifying the size of the printing-object document to the transferred clone size; and
creating print data by applying the clone printing option to the modified printing-object document.

11. The method as claimed in claim 10, further comprising the step of providing the print data to an external printing device.

12. The method as claimed in claim 10, wherein the clone printing option comprises at least one of a clone size, a size of paper on which the modified document is printed, a number of documents to be printed on a single sheet of printing paper, and whether or not cutting lines partitioning the documents to be printed on a single sheet of paper are to be displayed.

13. A printing control method providing a clone printing option for printing a plurality of identical printing-object documents of a clone size on a single sheet of printing paper, the method comprising the steps of:
providing a paper size list including clone sizes to an application program unit for creating a printing-object document;
displaying a print setting window comprising printing option items including the provided paper size list;
selecting a paper size to be used for printing the printing-object document through the displayed print setting window;
modifying the size of the printing-object document according to the selected paper size; and
creating print data by automatically applying the clone printing option to the created printing-object document if the selected paper size is the clone size.

14. The method as claimed in claim 13, wherein the clone printing option comprises at least one of a size of paper on which the created printing-object document is printed, a number of documents to be printed on a single sheet of printing paper, and whether or not cutting lines partitioning the documents to be printed on a single sheet of paper are to be displayed.

15. The method as claimed in claim 13, further comprising the step of providing the created print data to an external printing device.
